(19) United States
(12) Patent Application Publication
(10) Pub. No.: US 2019/0016332 A1
(43) Pub. Date: Jan. 17, 2019

(54) SMART PARKING SYSTEM AND PARKING TRACK GENERATION METHOD THEREOF

(71) Applicant: HYUNDAI MOBIS CO., LTD., Seoul (KR)

(72) Inventors: Ik Su SHIN, Seoul (KR); Dong Won LEE, Seoul (KR)

(21) Appl. No.: 16/030,862

(22) Filed: Jul. 10, 2018

(30) Foreign Application Priority Data
Jul. 11, 2017 (KR) 10-2017-0087548

(51) Int. Cl. B60W 30/06; B62D 15/02; B60W 50/00; G01S 15/02; G01S 15/93; G01S 7/52

(52) U.S. Cl. CPC B60W 30/06; B62D 15/0285; B60W 50/00; G01S 15/025; G01S 2015/932; G01S 7/52003; B60W 2550/10; B60W 2710/20; B60W 2050/0054; G01S 15/931

(57) ABSTRACT

A parking track generation system and method of a smart parking system may include: detecting, by a control unit, an obstacle through a camera and an ultrasonic sensor; applying, by the control unit, weights to the camera and the ultrasonic sensor, and determining a characteristic of the obstacle, when the obstacle is detected; generating, by the control unit, a straight parking track to a final destination when the determined characteristic indicates that the obstacle can be ignored, or generating a primary parking track by setting a primary destination to around the obstacle, when the determined characteristic indicates that the obstacle cannot be ignored; and generating, by the control unit, a secondary parking track to the final destination when the vehicle reaches the primary destination along the primary parking track.

### CROSS-REFERENCES TO RELATED APPLICATIONS

This application claims priority from and the benefit of Korean Application No. 10-2017-0087548, filed on Jul. 11, 2017, which is hereby incorporated by reference for all purposes as if fully set forth herein.

### BACKGROUND OF THE INVENTION

### Field

Exemplary embodiments of the invention relate to a smart parking system and a parking track generation method thereof, and more particularly, to a smart parking system and a parking track generation method thereof, which can apply weights to outputs of a camera and ultrasonic sensor depending on situations, detect an obstacle between the current position and a garage corresponding to the final destination, generate a primary parking track by setting a primary destination to around the obstacle when the obstacle is present, and generate a secondary parking track to the final destination when a vehicle reaches the primary destination.

### Discussion of the Background

The smart parking system refers to a system which can help a driver to easily park a vehicle, even though the inexperienced driver is an inexperienced driver who is poor at parking the vehicle. When the driver determines the position of an obstacle using a camera or ultrasonic sensor mounted on the vehicle and selects parallel parking or perpendicular parking in order to park the vehicle, the smart parking system performs a predetermined operation.

In particular, when the driver searches for a parking position while checking the rear view through a monitor and then finally selects the parking position of the vehicle, the smart parking system using a camera may automatically control the steering wheel of the vehicle using a sensor value, such that the vehicle is stably parked.

The related art of the invention is disclosed in Korean Patent Publication No. 2013-0065115 published on Jun. 19, 2013 and entitled “Method for deriving parking track for vehicle”.

In order to perform smart parking, the smart parking system generates a parking track to the final destination, and performs parking along the parking track.

However, when an obstacle is detected between the current position and the final destination, the smart parking system needs to generate an avoidance path depending on the state of the obstacle, and regenerate a parking track into which the avoidance path is reflected. Therefore, the reliabilities of the camera and the ultrasonic sensor for detecting an obstacle may be different from each other depending on a situation.

The above information disclosed in this Background section is only for enhancement of understanding of the background of the invention and, therefore, it may contain information that does not constitute prior art.

### SUMMARY OF THE INVENTION

Exemplary embodiments of the invention are directed to a smart parking system and a parking track generation method thereof, which can apply weights to a camera and ultrasonic sensor depending on situations, detect an obstacle between the current position and a garage corresponding to the final destination, generate a primary parking track by setting a primary destination to around the obstacle when the obstacle is present, and generate a secondary parking track to the final destination when a vehicle reaches the primary destination.

In one embodiment, a smart parking system may include: a camera; an ultrasonic sensor; and a control unit to detect an obstacle from the outputs of the camera and the ultrasonic sensor, apply weights to the outputs of the camera and the ultrasonic sensor when the obstacle is detected, and determine a characteristic of the obstacle. The control unit may generate a relatively straight parking track to a final destination when the determined characteristic indicates that the obstacle can be ignored, or to generate a primary parking track by setting a primary destination to around the obstacle when the determined characteristic indicates that the obstacle cannot be ignored, and to generate a secondary parking track to the final destination when a vehicle reaches the primary destination along the primary parking track.

The control unit may monitor noise of the ultrasonic sensor when applying weights, and configured to decrease the weight of the output of the ultrasonic sensor when the noise of the ultrasonic sensor is equal to or more than a preset value.

When applying weights, the control unit may be configured to apply the weights according to a distance and brightness, wherein the weights of the output of the camera and the ultrasonic sensor have an inverse relation.

When applying weights, the control unit may be configured to set the weight of the output of the ultrasonic sensor to a high value when the obstacle is detected at a short distance, and to set the weight of the camera to a high value when the obstacle is detected at a long distance.

When applying weights, the control unit may be configured to set the weight of the output of the camera to a high value when the brightness is high, and to set the weight of the output of the ultrasonic sensor to a high when the brightness is low.

The smart parking system may further include a warning unit. The control unit may be configured to operate the warning unit to warn that parking is impossible, when the determined characteristic indicates that the obstacle cannot be ignored.

In another embodiment, a method of generating a parking track for a smart parking system of a vehicle may include: detecting, by a control unit, an obstacle through a camera and an ultrasonic sensor; applying, by the control unit, weights to outputs of the camera and the ultrasonic sensor, and determining a characteristic of the obstacle, when the obstacle is detected; generating, by the control unit, a relatively straight parking track to a final destination when the determined characteristic indicates that the obstacle can be ignored, or generating a primary parking track by setting a primary destination to around the obstacle, when the determined characteristic indicates that the obstacle cannot be ignored; and generating, by the control unit, a secondary parking track to the final destination when the vehicle reaches the primary destination along the primary parking track.

The applying of the weights may include: monitoring, by the control unit, noise of the ultrasonic sensor; and decreasing, by the control unit, the weight of the output of the ultrasonic sensor when the noise of the ultrasonic sensor is equal to or more than a preset value.

In the applying of the weights, the control unit may apply weights according to a distance and a brightness, wherein the weights given to the outputs of the camera and the ultrasonic sensor have an inverse relation.

In the applying weights, the control unit may set the weight given to the output of the ultrasonic sensor to a high value when the obstacle is detected at a short distance, and set the weight given to the output of the camera to a high value when the obstacle is detected at a long distance.

In the applying of the weights, the control unit may set the weight given to the output of the camera to a high value when brightness is high, and set the weight given to the output of the ultrasonic sensor to a high value when the brightness is low.

The determining of a characteristic of the object may include: determining, by the control unit, a size of the obstacle; and determining, by the control unit, whether the obstacle is moving.

The generating of the secondary parking track may include: detecting, by the control unit, the obstacle and determining the characteristic of the obstacle, when the obstacle is present; and generating, by the control unit, the secondary parking track to the final destination when the determined characteristic indicates that the obstacle can be ignored, or warning a user that parking is impossible, when the determined characteristic indicates that the obstacle cannot be ignored.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram simply illustrating a smart parking system which is applied to a parking track generation method in accordance with an embodiment of the invention.

FIG. 2 is a flowchart illustrating the parking track generation method of the smart parking system in accordance with the embodiment of the invention.

FIGS. 3A and 3B illustrate parking tracks which are generated by the parking track generation method of the smart parking system in accordance with the embodiment of the invention.

### DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Hereafter, a smart parking system and a parking track generation method thereof in accordance with embodiments of the invention will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components.

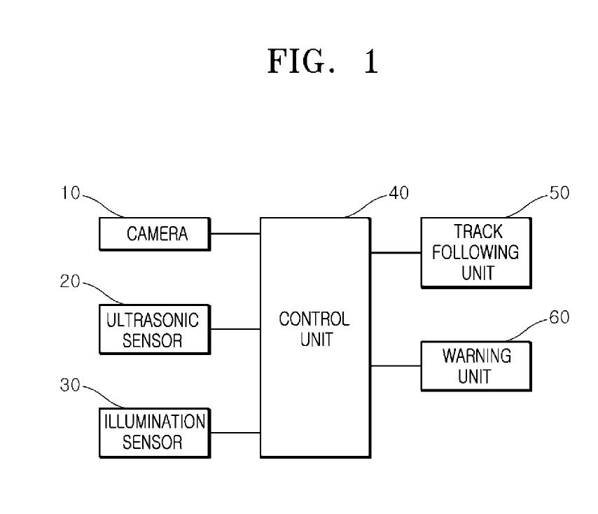

FIG. 1 is a block diagram simply illustrating a smart parking system which is applied to a parking track generation method in accordance with an embodiment of the invention.

As illustrated in FIG. 1, the smart parking system may include a camera 10, an ultrasonic sensor 20, an illumination sensor 30, a track following unit 50, a control unit 40 and a warning unit 60.

The camera 10 may film an object or vehicle around an ego vehicle, and set a weight to a high value when sensing an obstacle at a middle distance and long distance.

The ultrasonic sensor 20 may sense a distance to an object or vehicle around the ego vehicle. The ultrasonic sensor 20 may be disposed at the front/rear or left/right surface of the vehicle, and set a weight to a high value when sensing an obstacle at a short distance and middle distance.

The illumination sensor 30 may sense brightness around the vehicle. Based on the sensed brightness, the control unit 40 may determine whether it is day or night or whether it is dark or bright due to a turn-on/off of the headlight. Thus, when an obstacle is recognized through the camera 10, the control unit 40 may change the weight.

The track following unit 50 may drive the vehicle to follow the track generated by the control unit 40. That is, the track following unit 50 may not only drive and reverse the vehicle but also steer and move the vehicle along the generated track, through driving control and steering control.

The control unit 40 may detect an obstacle through the camera 10 and the ultrasonic sensor 20, and apply a weight to the camera 10 and the ultrasonic sensor 20 depending on situations, in order to determine the characteristic of the obstacle. Then, the control unit 40 may generate a straight parking track to a garage corresponding to the final destination when the obstacle can be ignored, or set a primary destination to around the obstacle and generate a primary parking track, when the obstacle cannot be ignored. Then, when the vehicle reaches the primary destination along the primary parking track, the control unit 40 may generate a secondary parking track to the final destination.

When another obstacle which cannot be ignored is detected while the secondary parking track is generated, the control unit 40 may output a warning through the warning unit 60, the warning informing the driver that automatic parking is impossible.

The parking track generation method of the smart parking system will be described in detail as follows.

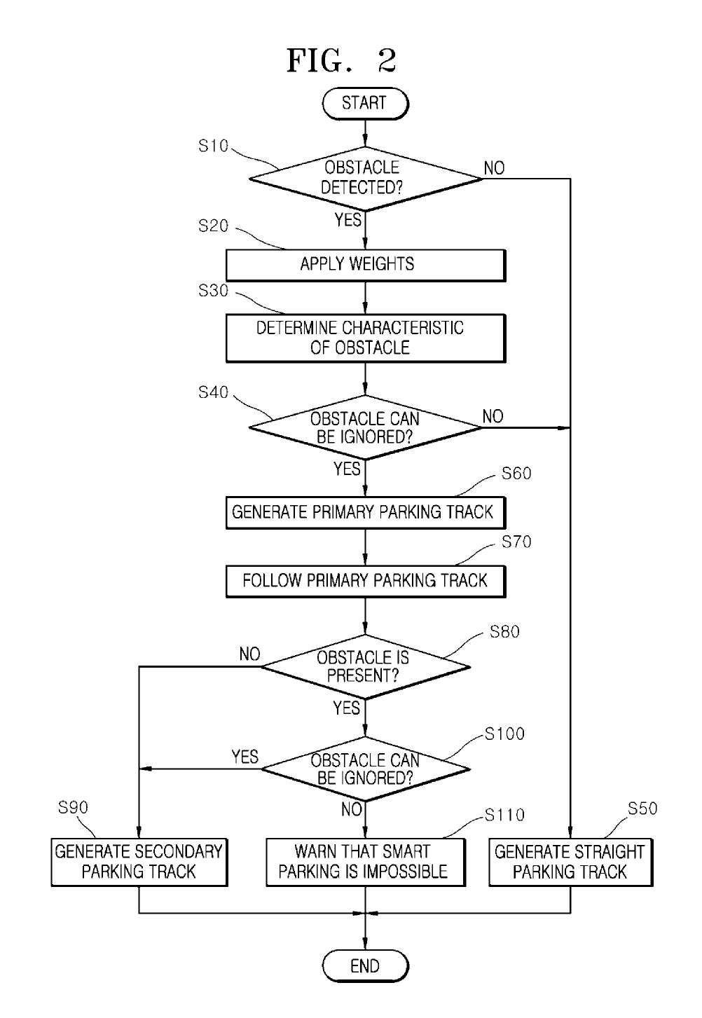

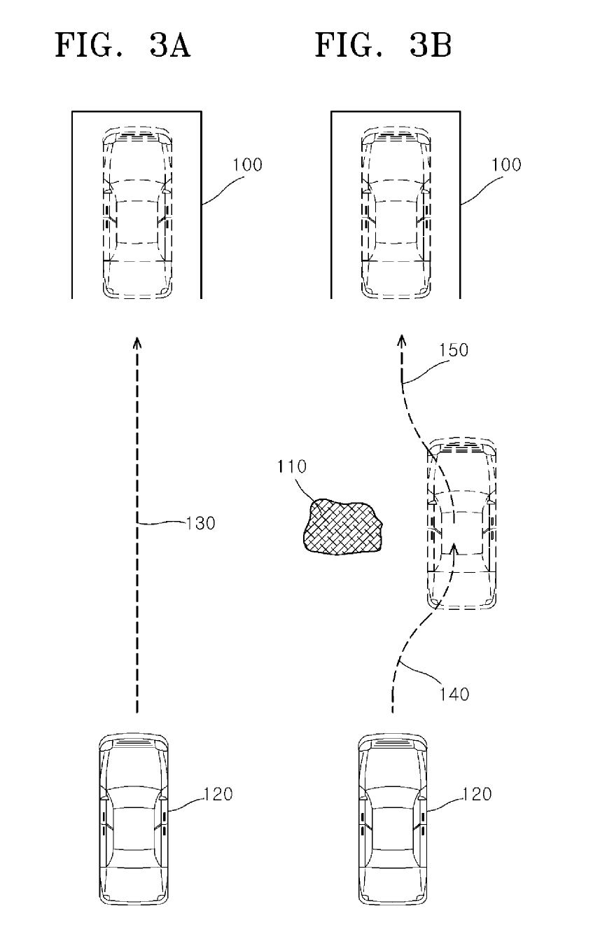

FIG. 2 is a flowchart illustrating the parking track generation method of the smart parking system in accordance with the embodiment of the invention, and FIGS. 3A and 3B illustrate parking tracks which are generated by the parking track generation method of the smart parking system in accordance with the embodiment of the invention.

As illustrated in FIG. 2, the parking track generation method of the smart parking system in accordance with the embodiment of the invention may start with step S10 in which the control unit 40 detects an obstacle 110 through the camera 10 and the ultrasonic sensor 20.

When the obstacle 110 is not detected at step S10, the control unit 40 may generate a straight parking track 130 to a garage 100 corresponding to the final destination as illustrated in FIG. 3A, at step S50.

On the other hand, when the obstacle 110 is detected at step S10, the control unit 40 may apply weights to the camera 10 and the ultrasonic sensor 20 at step S20.

At this time, when the weights are applied to the camera 10 and the ultrasonic sensor 20, the weights may be applied according to the distance and brightness.

In other words, when the obstacle 110 is sensed at a middle distance or long distance, the control unit 40 may set the weight of the camera 10 to a high value, and when the obstacle 110 is sensed at a short distance or middle distance, the control unit 40 may set the weight of the ultrasonic sensor 20 to a high value. Furthermore, when the obstacle 110 is detected at the middle distance, the control unit 40 may set the weight by reflecting a reliable value obtained through experiments.

The short distance, the middle distance and the long distance may be set to the optimal distances based on the performances of the camera 10 and the ultrasonic sensor 20.

Depending on the brightness of the surrounding environment, inputted from the illumination sensor 30, the control unit 40 may increase the weight of the camera 10 in a bright place, or increase the weight of the ultrasonic sensor 20 in a dark place.

The ultrasonic sensor 20 may monitor noise. When the noise is equal to or more than a preset value, the weight of the ultrasonic sensor 20 may be decreased.

In the present embodiment, trade-off weights may be applied to the camera 10 and the ultrasonic sensor 20. That is, when a weight of A is applied to the camera 10, a weight of (1-A) may be applied to the ultrasonic sensor 20.

Estimated distance=(A×estimated distance of ultrasonic sensor+(1-A)×estimated distance of camera)/2/ [Equation 1]

That is, the control unit 40 may calculate an estimated distance to the obstacle 110 by applying the weights A and (1-A) to a distance estimated through the camera 10 and a distance estimated through the ultrasonic sensor 20.

After applying the weights to the camera 10 and the ultrasonic sensor 20, the control unit 40 may determine the characteristic of the detected obstacle 110 at step S30.

After estimating the distance to the obstacle 110 and determining the characteristic of the obstacle, the control unit 40 may determine whether the size of the obstacle 110 can be ignored, at step S40.

For example, when the obstacle 110 is a small stationary object such as a small stone, the obstacle 110 can be ignored. However, when the obstacle 110 has a size equal to or more than a predetermined size or is a moving object, the control unit 40 may determine that the obstacle 110 cannot be ignored.

Therefore, when it is determined at step S40 that the obstacle 110 can be ignored, the control unit 40 may generate the straight parking track 130 to the garage 100 at step S50.

However, when it is determined at step S40 that the obstacle 110 cannot be ignored, the control unit 40 may set a primary destination to around the obstacle 110 and generate a primary parking track 140, in order to avoid the obstacle 110 as illustrated in FIG. 3B, at step S60.

For example, the primary destination may be set to a position which is separated by a preset distance from the obstacle 110 and at which the vehicle can be parallel-parked. At this time, when the obstacle 110 is a moving obstacle, the control unit 40 may set the primary destination in the opposite direction of the moving direction of the obstacle 110.

Therefore, the control unit 40 may set the primary parking track 140 such that the vehicle can be parked in parallel to the obstacle 110. At this time, the control unit 40 may also set the initial reverse track such that the vehicle can be parallel parked at a place separated from the obstacle 110.

Then, as illustrated in FIG. 3B, the control unit 40 may move the vehicle 120 to the parallel-parking position with respect to the obstacle 110 corresponding to the primary destination, along the generated primary parking track 140, at step S70.

In order to follow the primary parking track 140, the control unit 40 of the smart parking system may operate the track following unit 50 to move the vehicle through driving control and steering control.

As such, when the vehicle 120 reaches the primary destination, the control unit 40 may determine whether an obstacle 110 is present between the primary destination and the garage 100 corresponding to the final destination, at step S80.

When determining whether the obstacle 110 is present, the control unit 40 may perform the same process as the process of detecting the obstacle 110 through the camera 10 and the ultrasonic sensor 20.

When the determined characteristic of step S80 indicates that no obstacle 110 is present, the control unit 40 may generate a secondary parking track 150 to the garage 100 from the primary destination as illustrated in FIG. 3B, at step S90.

On the other hand, when the determined characteristic of step S80 indicates that the obstacle 110 is present, the control unit 40 may determine whether the obstacle 110 can be ignored, based on the characteristic of the obstacle 110, at step S100.

For example, when the obstacle 110 is a small stationary object such as a small stone, the obstacle 110 can be ignored. However, when the obstacle 110 has a size equal to or more than a predetermined size or is a moving obstacle, the control unit 40 may determine that the obstacle 110 cannot be ignored. In this case, the control unit 40 may determine that smart parking is impossible, in consideration of the distance to the garage 100 with the vehicle moved to the primary destination for smart parking.

When the determined characteristic of step S100 indicates that the obstacle 110 can be ignored, the control unit 40 may generate the secondary parking track 150 to the garage 100 from the primary destination.

However, when the destination result of step S100 indicates that the obstacle 110 cannot be ignored, the control unit 40 may control the warning unit 60 to warn a user that smart parking is impossible. Then, the user may remove the obstacle 110 in person.

In accordance with the embodiment of the invention, the parking track generation method of the smart parking system may apply the weights to the camera and the ultrasonic sensor depending on situations, detect an obstacle between the current position and the garage corresponding to the final destination, and generate the primary parking track by setting the primary destination to around the obstacle when the obstacle is present. Then, when the vehicle reaches the primary destination, the parking track generation method may generate the secondary parking track to the final destination, and thus not only detect the obstacle through the camera and the ultrasonic sensor which are optimized to the situation, but also regenerate a track to the final destination after generating an avoidance track to avoid the obstacle, which makes it possible to generate a stable and reliable parking track.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A smart parking system comprising:
a camera;
an ultrasonic sensor; and
a control unit to detect an obstacle from outputs of the camera and the ultrasonic sensor, apply weights to the outputs of the camera and the ultrasonic sensor when the obstacle is detected, and determine a characteristic of the obstacle,
wherein the control unit is configured to generate a relatively straight parking track to a final destination when the determined characteristic indicates that the obstacle can be ignored, or to generate a primary parking track by setting a primary destination to around the obstacle when the determined characteristic indicates that the obstacle cannot be ignored, and to generate a secondary parking track to the final destination when a vehicle reaches the primary destination along the primary parking track.

2. The smart parking system of claim 1, wherein the control unit monitors noise of the ultrasonic sensor when applying weights, and is configured to decrease the weight of the output of the ultrasonic sensor when the noise of the ultrasonic sensor is equal to or more than a preset value.

3. The smart parking system of claim 1, wherein when applying weights, the control unit is configured to apply weights according to a distance and a brightness, wherein the weights of the outputs of the camera and the ultrasonic sensor have an inverse relation.

4. The smart parking system of claim 3, wherein when applying weights, the control unit is configured to set the weight of the output of the ultrasonic sensor to a high value when the obstacle is detected at a short distance, and to set the weight of the output of the camera to a high value when the obstacle is detected at a long distance.

5. The smart parking system of claim 3, wherein when applying weights, the control unit is configured to set the weight of the output of the camera to a high value when the brightness is high, and to set the weight of the output of the ultrasonic sensor to a high value when the brightness is low.

6. The smart parking system of claim 1, further comprising a warning unit,
wherein the control unit is configured to operate the warning unit to warn that parking is impossible, when the determined characteristic indicates that the obstacle cannot be ignored.

7. A method of generating a parking track for a smart parking system of a vehicle, the method comprising the steps of:
detecting, by a control unit, an obstacle through a camera and an ultrasonic sensor;
applying, by the control unit, weights to outputs of the camera and the ultrasonic sensor, and determining a characteristic of the obstacle, when the obstacle is detected;
generating, by the control unit, a relatively straight parking track to a final destination when the determined characteristic indicates that the obstacle can be ignored, or generating a primary parking track by setting a primary destination around the obstacle, when the determined characteristic indicates that the obstacle cannot be ignored; and
generating, by the control unit, a secondary parking track to the final destination when the vehicle reaches the primary destination along the primary parking track.

8. The method of claim 7, wherein the step of applying weights comprises:
monitoring, by the control unit, noise of the ultrasonic sensor; and
decreasing, by the control unit, the weight of the output of the ultrasonic sensor when the noise of the ultrasonic sensor is equal to or more than a preset value.

9. The method of claim 7, wherein in the step of applying weights, the control unit applies weights according to a distance and a brightness, wherein the weights given to the output of the camera and the ultrasonic sensor have an inverse relation.

10. The method of claim 9, wherein in the step of applying weights, the control unit sets the weight given to the output of the ultrasonic sensor to a high value when the obstacle is detected at a short distance, and sets the weight given to the output of the camera to a high value when the obstacle is detected at a long distance.

11. The method of claim 9, wherein in the step of weights, the control unit sets the weight given to the output of the camera to a high value when brightness is high, and sets the weight given to the output of the ultrasonic sensor to a high value when the brightness is low.

12. The method of claim 7, wherein the step of determining a characteristic of the obstacle comprises:
determining, by the control unit, a size of the obstacle; and
determining, by the control unit, whether the obstacle is moving.

13. The method of claim 7, wherein the step of generating of the secondary parking track comprises:
detecting, by the control unit, the obstacle and determining the characteristic of the obstacle, when the obstacle is present; and
generating, by the control unit, the secondary parking track to the final destination when the determined characteristic indicates that the obstacle can be ignored, or warning a user that parking is impossible, when the determined characteristic indicates that the obstacle cannot be ignored.
